(19) United States
(12) Patent Application Publication
(10) Pub. No.: US 2006/0207384 A1
(43) Pub. Date: Sep. 21, 2006

(54) Portal axle apparatus

(75) Inventors: Robert B. Hardy, Clifton, CO (US); Phillip Adam Rawlings, Salt Lake City, UT (US)

Correspondence Address: ROBERT B HARDY, 424 NORTH 700 EAST, KAYSVILLE, UT, 84037, US

(73) Assignee: PORTAL TEK LLC

(21) Appl. No.: 11/375,861

(22) Filed: Mar. 15, 2006

Related U.S. Application Data
(60) Provisional application No. 60/663,430, filed on Mar. 18, 2005.

(51) Int. Cl. F16H 35/00

(52) U.S. Cl. 74/640

(57) ABSTRACT

The present invention relates generally to portal axle gears. Embodiments of the invention provide for full-floating portal gear axles and an indexed steering arm. The full floating portal axle, for example, displaces vehicular weight from the portal gears onto bearings within the portal axel.

### RELATED APPLICATIONS

The present application claims the benefit under 35 U.S.C. § 119(e) of U.S. provisional application Ser. No. 60/663,430, filed on Mar. 18, 2005, entitled “Portal Axle Apparatus and Method,” which is incorporated herein by reference in its entirety.

### FIELD OF THE INVENTION

This invention relates to axle design and, more particularly, to novel systems and methods for portal axles.

### BACKGROUND OF THE INVENTION

Traditional portal axles have many weaknesses and/or problems with use by the general public. The gears both in the differential and the Portal gear box are hard to buy and expensive due to limited supply. Traditional portal axles are also prone to gear failure.

For example, in traditional portal axles the vehicle or machine weight is placed directly on the gears within the portal. This weight may damage the gears during operation and lowers the gross vehicle weight allowable for a portal axle. Furthermore, traditional axles do not accommodate horizontal torques. For example, during a turn or if a wheel was subject to horizontal resistance a horizontal torque would be applied to the portal axle. Traditional axles were unable to withstand this torque without damage.

Thus there is need in the art for more robust portal axles that may withstand horizontal torques and that do not place vehicular loads directly on the gears.

### SUMMARY OF THE INVENTION

One embodiment of the present invention provides for a portal gear box housing comprising an upper gear housed within the portal gear box; a lower portal gear housed within the portal gear box and in contact with the upper gear; at least one lower inner bearing mount and at least one lower outer bearing mount; a lower inner bearing mounted at the lower inner bearing mount; and a lower outer bearing mounted at the lower outer bearing mount. In such an embodiment, the output shaft is rotatably coupled within the lower inner bearing and within the lower outer bearing and coupled to the lower portal gear thus fully suspending the output shaft within the portal gear box, and wherein the lower inner bearing and the lower outer bearing alleviate the load on the torque bearing surfaces of the lower portal gear. The upper and lower portal gears may be capable of being loaded within the portal gear box without disassembly. The portal gear box may also comprise the following a spindle mounting plate, an indexed steering arm, and an input yolk coupled with the upper gear. In a specific embodiment the upper gear comprises fewer teeth than the lower portal gear. In another variant the portal gear box housing is a single unit.

In another embodiment of the present invention, the portal axle may further comprise at least one upper inner bearing mount and at least one upper outer bearing mount; a upper inner bearing mounted at the upper inner bearing mount; and a upper outer bearing mounted at the upper outer bearing mount. The input yoke may be, for example, rotatably coupled within the upper inner bearing and within the upper outer bearing and coupled to the upper gear thus fully suspending the input yoke within the portal gear box, and wherein the upper inner bearing and the upper outer bearing alleviate the load on the torque bearing surfaces of the upper gear.

In another embodiment of the present invention, a portal axle comprises a portal gear box housing with a lower inner bearing mount and a lower outer bearing mount; an output shaft; an input yolk; an upper gear coupled with the input yolk; a lower portal gear coupled with the output shaft and in contact with the upper gear; a lower inner bearing mounted within the portal gear box at the lower inner bearing mount; and a lower outer bearing mounted within the portal gear box at the lower outer bearing mount. The output shaft may be rotatably coupled with the lower inner bearing and the lower outer bearing. This portal axle may further comprise a spindle mounting plate encasing the output shaft; a rotor coupled with the spindle mounting plate; and a hub assembly coupled with the rotor. The spindle mounting plate may be within the hub assembly.

Yet another embodiment of the present invention provides for a vehicle comprising an engine, a drive train and wheels; a portal gear box housing coupled with each wheel of the vehicle, wherein the portal gear boxes in combination support the weight of the vehicle, the portal gearbox comprising: a lower inner bearing mount and a lower outer bearing mount, wherein the portal gear box; an output shaft; an input yolk coupled with the drive train of the vehicle; an upper gear coupled with the input yolk; a lower portal gear coupled with the output shaft and in contact with the upper gear; a lower inner bearing mounted within the portal gear box at the lower inner bearing mount; and a lower outer bearing mounted within the portal gear box at the lower outer bearing mount. The output shaft may be rotatably coupled with the lower inner bearing and the lower outer bearing. The portal vehicle may further comprise a spindle mounting plate encasing the output shaft; a rotor coupled with the spindle mounting plate; and a hub assembly coupled with the rotor. The spindle mounting plate may be housed within the hub assembly.

### BRIEF DESCRIPTION OF THE FIGS.

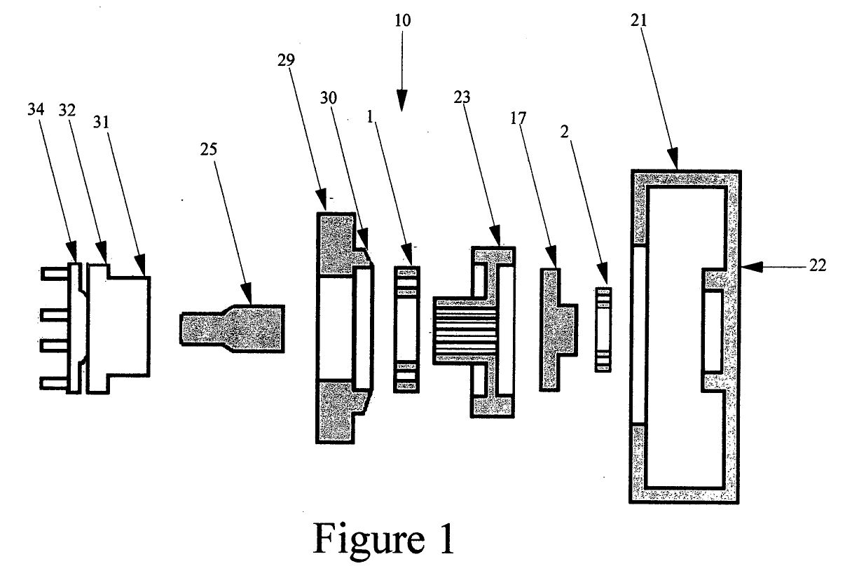

FIG. 1 is an exploded, top, partial cross sectional view of a portal axle assembly according to one embodiment of the present invention.

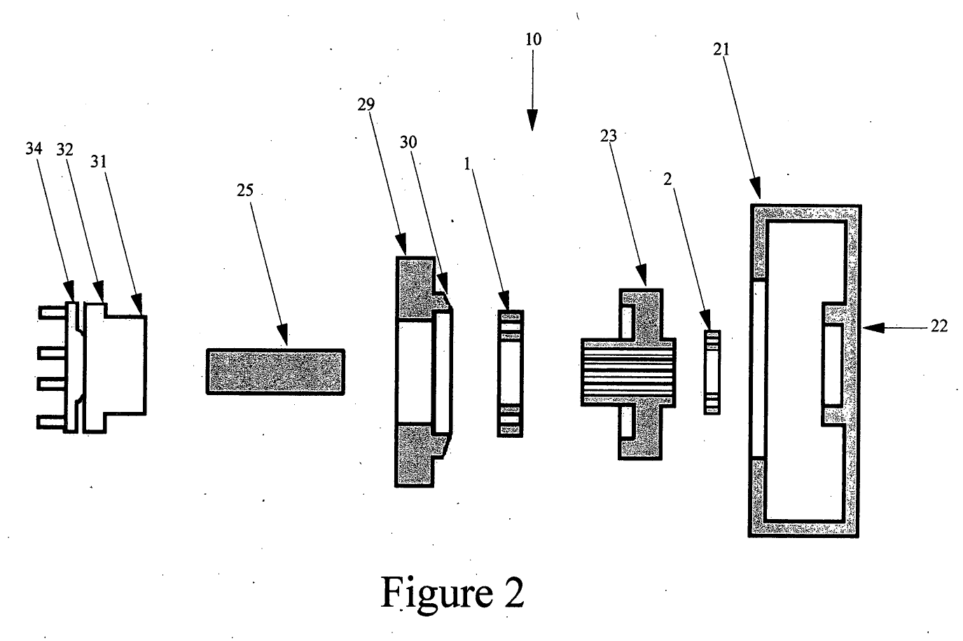

FIG. 2 is an exploded, top, partial cross sectional view of an alternative portal axle assembly according to another \ embodiment of the present invention.

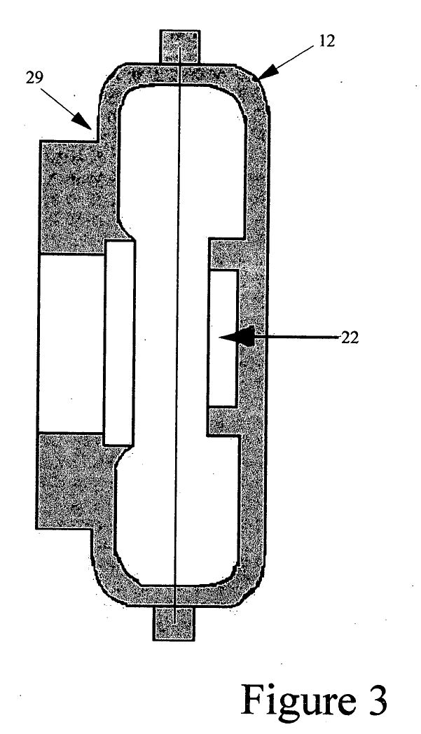

FIG. 3 is a top cross sectional view of an alternative embodiment of a portal axle housing in accordance with the present invention according to one embodiment of the present invention.

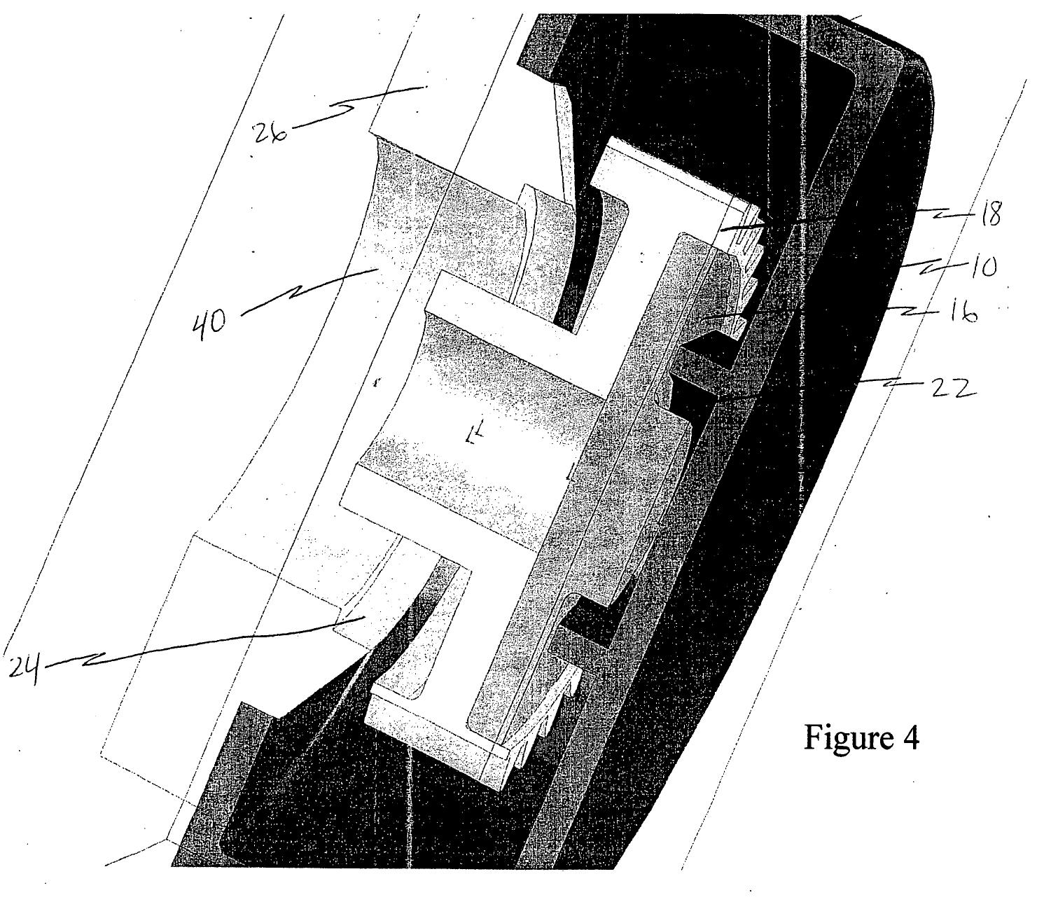

FIG. 4 is a partial, cutaway, perspective view of the portal axle assembly of FIG. 1 according to one embodiment of the present invention.

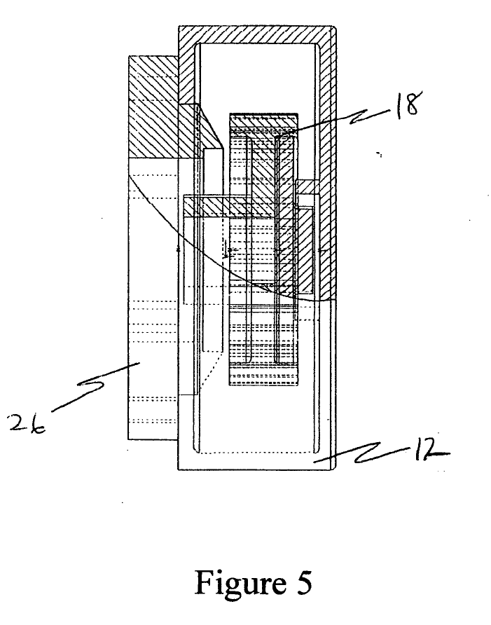

FIG. 5 is a top, partial cutaway, assembly view of the portal axle assembly of FIG. 1 according to one embodiment of the present invention.

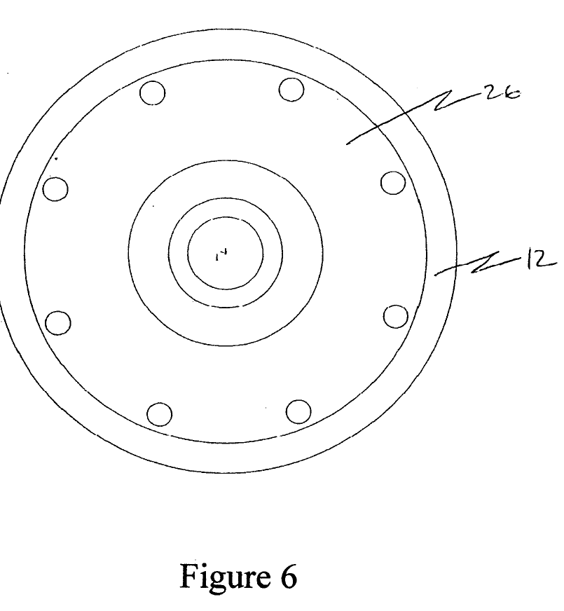

FIG. 6 is a side view of the portal axle assembly of FIG. 5 according to one embodiment of the present invention.

FIG. 7 is a side view of one embodiment of a wheel hub plate according to one embodiment of the present invention.

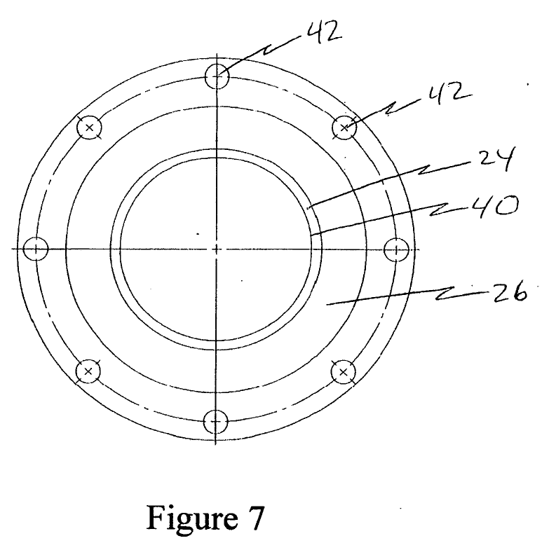

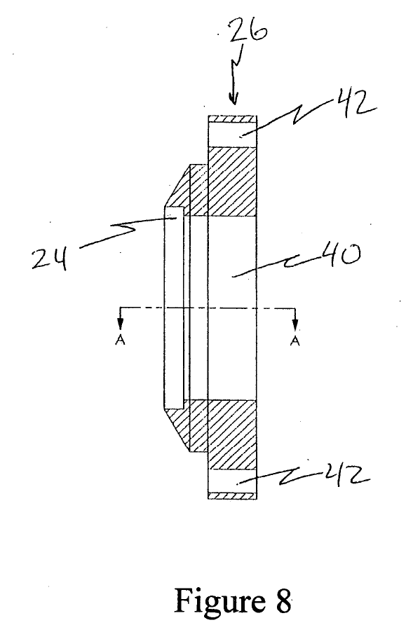

FIG. 8 is a side, cross-sectional view of the wheel hub plate of FIG. 7 according to one embodiment of the present invention.

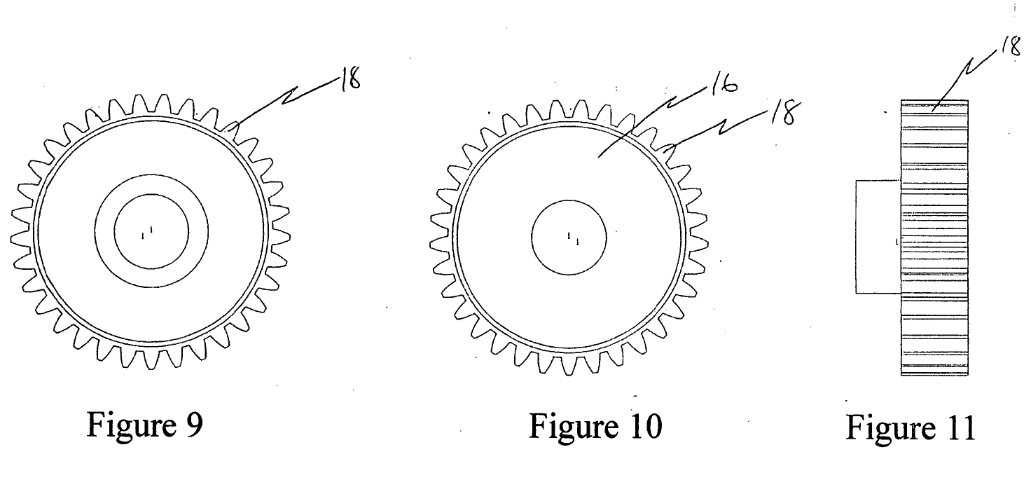

FIG. 9 is a side view of one embodiment of a lower portal gear according to one embodiment of the present invention.

FIG. 10 is an opposite view of the portal gear of FIG. 9 according to one embodiment of the present invention.

FIG. 11 is a top view of the portal gear of FIG. 9 according to one embodiment of the present invention.

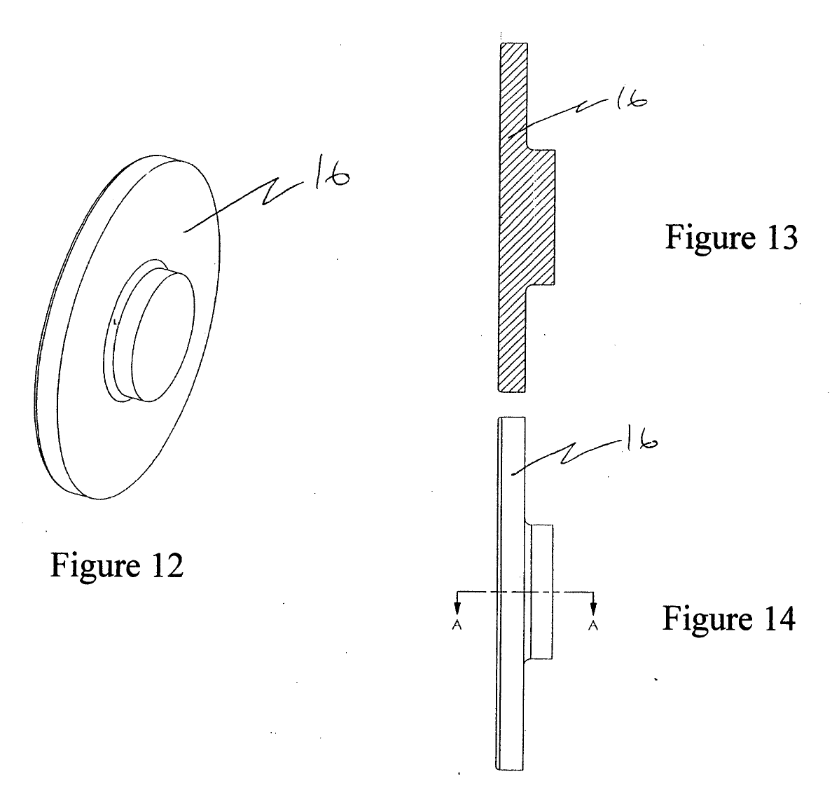

FIG. 12 is a perspective view of one embodiment of a portal hub adapter according to one embodiment of the present invention.

FIG. 13 is a side, cross-sectional view of the portal hub adapter of FIG. 12 according to one embodiment of the present invention.

FIG. 14 is a side view of the portal hub adapter of FIG. 12 according to one embodiment of the present invention.

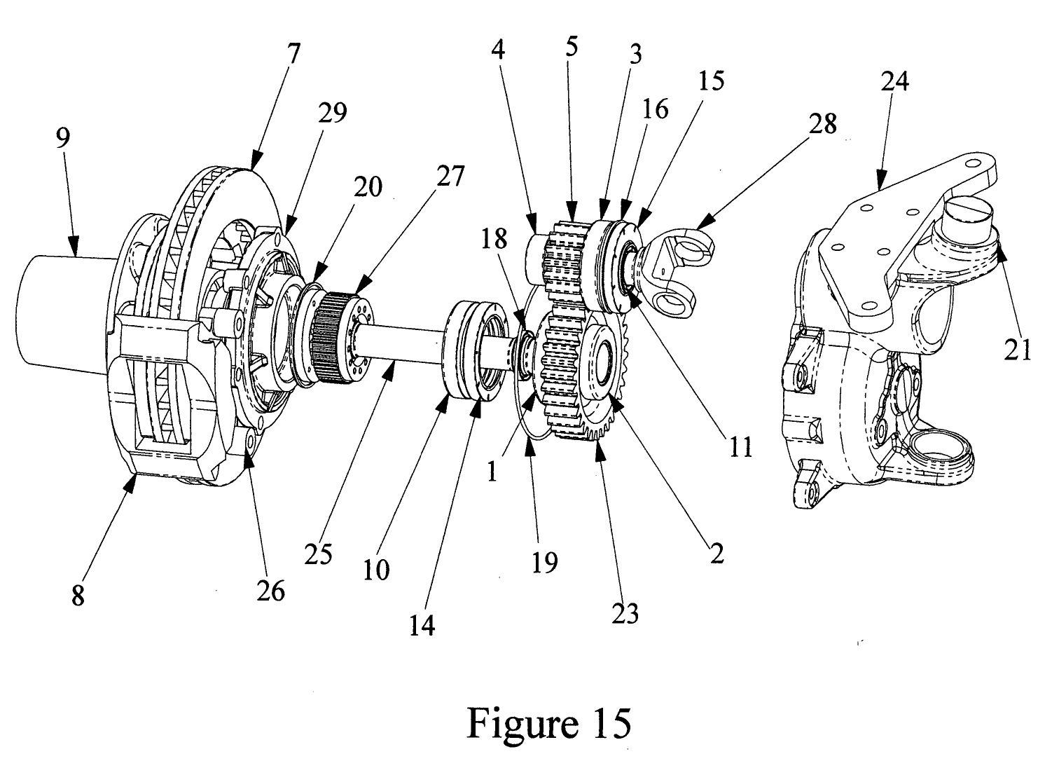

FIG. 15 is an exploded view of a front gear case assembly of one embodiment of the present invention.

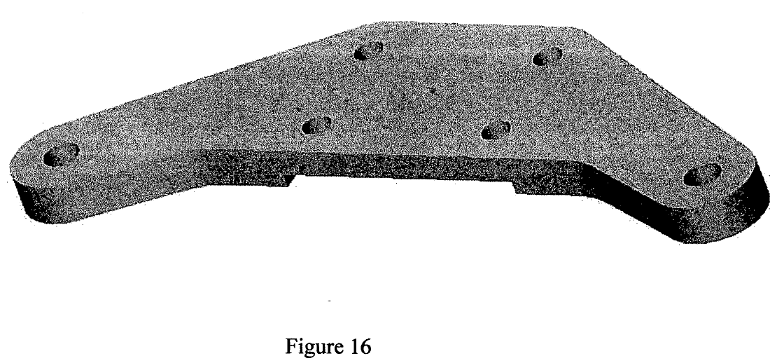

FIG. 16 is an indexed steering arm according to another embodiment of the present invention.

### DESCRIPTION OF THE PREFERRED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, but is merely representative of various embodiments of the invention. The illustrative embodiments of the invention will be best understood by reference to the drawings, wherein like parts are designated by like numerals throughout.

A portal axle 10 may be attached, for example, to a rotating wheel of a vehicle and may be configured as a steering or non steering portal axle assembly. For example, vehicles require the capability to steer or turn in different directions may be located, for example, on the front or rear of the vehicle or both as required. In addition, the portal axle 10 may be operated as a drive axle or a free wheeling axle. For example, a portal axle 10 may be supplied with power via a vehicle drive train or through an input yoke or shaft, or it may simply roll freely while disconnected to the drive train.

As shown in FIG. 1, one embodiment of the present invention shows a portal gear box 21 that may be constructed of cast iron, stainless steel, aluminum, steel or any other material capable of supporting the rigors of a drive train assembly. The portal gear box 21 may house a lower inner bearing 2, a lower outer bearing 1, and a lower portal gear 23. Attached to the portal gear box 21 is the spindle/mounting plate 29. Coupled with the lower portal gear 23 is an output shaft 25. The output shaft 25 may be coupled, for example, with the lower portal gear 23 via, for example, splines on the shaft. A lower inner bearing mount 22 may be cast into the rear or inner portion of the portal gear box 21. A lower inner bearing mount 22 may be configured to accept the lower inner bearing 2. A lower inner bearing mount 22 may be configured to accept a sealed cartridge bearing in which the bearing fits within the mount with a snug or pressed fit. Alternatively, the lower inner bearing mount 22 may be configured as a bearing race for accepting a traditional roller bearing cartridge in which the bearing rolls within the bearing race in the lower inner bearing mount 22.

A lower inner bearing 2, for example, can be seated within the lower inner bearing mount 22. An inner lower bearing 2 rotatably connects the portal gear box 21 to the lower portal gear 18. An inner lower bearing 14 may also rotatably connect a portal gear box 21 to a modified portal gear 36. The lower inner gear bearing 2 and the lower outer gear bearing 1, for example, may be a sealed cartridge bearing, a cartridge bearing, or a traditional roller style wheel type bearing. An inner lower portal gear bearing 14 may also be substituted for another type of device that allows the output shaft 25 and gear 23 to be rotatably connected within the portal gear box 21.

The spindle/mounting plate 29 may include an outer lower bearing mount 30. When the spindle/mounting plate 29 is coupled with the portal gear box 21 the outer lower bearing is securely mounted with in the outer lower bearing mount 30. As discussed in conjunction with the inner lower bearing mount 22 there are a number of ways to mount the outer lower bearing 1 within the outer bearing mount 30. From within the portal gear box 21, the output shaft 25 is coupled with the lower portal gear 23 and extends through the spindle mounting plate 29 and is coupled with the hub assembly 31, 32, 34.

FIG. 1 shows a hub adapter 17 that may be seated, for example, within an inner lower portal gear bearing 17 and connects an inner lower portal gear bearing 14 to a lower portal gear 18. The surface of a hub adapter 17 may be machined to accept a variety of inner lower portal gear bearings 14 including but not limited to cartridge bearings or traditional roller bearings. A hub adapter 17 may be pressed, welded or otherwise attached within the inner surface of a lower portal gear 18. Alternatively, a hub adapter may be machined as part of the lower portal gear as shown in item 23 of FIG. 2. A hub adapter 17 may be made of titanium, steel including high strength or hardened steel or any other material capable of withstanding the rigors of a vehicle drive train.

A lower portal gear 18 transfers the power from the vehicle drive train via the upper portal gear to the output shaft 25. A lower portal gear 18 may have any manner of teeth or drive configuration compatible with a vehicle drive train. A lower portal gear 18 may be constructed of any manner of titanium, steel or high strength steel or any other material capable of withstanding the rigors of a vehicle drive train. The lower portal gear 18, for example, may be machined to accept a variety of outer lower portal gear bearings 1 or other rotating mechanism including but not limited to sealed cartridge bearings, cartridge bearings or traditional roller style bearings. A lower portal gear 18 may have splines or any other 10 torque transferring mechanism capable of transferring torque from the gears to the output shaft 25.

An outer lower portal gear bearing 1 is seated within the lower outer bearing mount 30 and rotatably connects the lower outer bearing mount 30 to the lower portal gear 18. The outer lower portal gear bearing 1 may be a sealed cartridge bearing, a cartridge bearing or a traditional roller style wheel bearing. The outer lower portal gear bearing 1 may also be substituted for another type of device that allows an output shaft 25 to be rotatably connected with respect to a spindle/mounting plate 29.

A spindle/mounting plate 29 may be attached to the outside of a portal gear box 21. A spindle/mounting plate 29 may be made constructed of steel, cast iron, aluminum or any other material capable of withstanding the rigors of a drive train application. A spindle/mounting plate 29 may have a lower outer bearing mount 30 machined, cast or otherwise formed into the surface facing the inside of the portal gear box 21 to aid in rotatably connecting the spindle/mounting plate 29 to a lower portal gear 18 via an outer lower portal gear bearing 1. A spindle/mounting plate 29 may have an inner surface that is capable of accepting a wheel hub 31, 32, 34. The inner surface of the spindle/mounting plate 29 may be machined, cast or otherwise formed into the surface of the spindle/mounting plate 29 facing the outside of the portal gear box 21. The inner surface forms a surface in which a wheel hub 32 may be seated into a spindle/mounting plate 29. A 5 spindle/mounting plate 29 may be mounted in a variety of ways to the portal gear box 21 including but not limited to bolts, hinges, welds or any other method of attachment capable of withstanding the rigors of a vehicle drive train.

An output shaft 25 transfers the torque from a lower portal gear 18 to a wheel hub 32. An output shaft 25 may utilize splines or any other method of transferring torque from a lower portal gear 18 to a wheel hub 32. An output shaft 25 may be configured to adapt from a gear having one diameter to a hub having another diameter as shown in FIG. 1. Alternatively, an output shaft 25 may be configured for a gear and a hub having the same diameters as shown in FIG. 2. An output shaft 25 may have a variety of different spline configurations including uniform splines along the shaft or two or more sets of splines depending on the varying wheel hub 32 and lower portal gear 18 configurations.

A wheel hub 32 may mount to a spindle/mounting plate 29. A wheel hub 32 may have any manner of wheel bearing 31 capable of allowing the output shaft 25 and the wheel mounting plate 34 to rotate within the wheel hub 32. Typically a wheel hub 32 will be of a standard configuration supplied by a variety of automotive manufacturers. A wheel bearing 31 attached to a wheel hub 32 may be a sealed bearing cartridge or other cartridge bearing. Alternatively, a wheel bearing 30 may be a traditional roller style wheel bearing. The wheel hub 32 may be mounted to a spindle/mounting plate 29 in a variety of different configurations. Depending on the type of wheel bearing 30, a wheel hub 32 maybe pressed into the spindle/mounting plate 29 or may be bolted or otherwise fixed to the spindle/mounting plate 29. The tire mounting plate 34 may be configured to accept a variety of different bolt patterns corresponding with the wheels that a customer wishes to use on their vehicle.

Referring to FIG. 2, a modified portal gear 36 may be a manufactured with a hub adapter 17 as part of the lower portal gear 29. A modified portal gear 23 may have splines that are identical to a commonly used wheel hub 32 so that the output shaft 25 may have uniform splines and be of uniform diameter.

Referring to FIG. 3, a portal gear box 21 and spindle/mounting plate 29 may have a variety of different configurations depending on the original design or manufacturer of the portal gear box 21. For instance in FIG. 3, the spindle/mounting plate 29 is shaped to form a larger part of the apparatus 10. In this embodiment, a portal gear box 21 is reduced in size to accommodate the spindle/mounting plate 29. Thus the portal axle 10 is capable of being adapted to a variety of different portal gear box 21 and spindle/mounting plate 29 configurations.

In another embodiment, the input shaft may also be free-floating in that the input shaft is rotatably coupled with at least two bearings, an inner upper bearing and a lower upper bearing that are mounted within the portal gear box. The input shaft is coupled with the upper gear. In such an embodiment, both the upper and lower gears are free-floating and have negligible vehicle weight on the torque bearing surfaces.

Referring to FIG. 4, a lower portal gear in some embodiments may have splines or some other form of drive mechanism on the inside diameter corresponding with an output shaft 25. Note that these splines are not depicted in FIG. 4. Also note that in FIG. 4 the inner lower portal bearing 14 is not depicted between the lower inner bearing mount 22 and the hub adapter 17. In addition, the outer lower portal gear bearing 1 is not depicted between the lower portal gear 18 and the lower outer bearing mount 30.

Referring to FIG. 5, a wheel hub plate is mounted to a portal gear box 21. The lower portal gear 18 is shown in an assembly drawing without the inner lower portal gear bearing 14 or the outer lower portal gear bearing 1.

Referring to FIG. 6, a spindle/mounting plate 29 is shown mounted to a partial depiction of a portal gear box 21.

Referring to FIG. 7, the inside surface of a spindle/mounting plate 29 is shown with the inner surface 40 in which the wheel hub 32 seats. In addition, a lower outer bearing mount 30 is depicted. The spindle/mounting plate 29 depicted in FIG. 7 is configured to be mounted to a portal gear box 21 with bolts via the bolt holes 42.

Referring to FIG. 8, a side cross sectional view of a wheel hub plate 28 includes bolt holes 40 for mounting the wheel hub plate 28 to a portal gear box 21. In addition, a lower outer bearing mount 30 is depicted. An inner surface 40 is shown and is the surface in which the wheel hub 32 may seat.

FIG. 9 and 10 show two opposing views of a one embodiment of a lower portal gear according to one embodiment of the present invention. FIG. 11 shows the top view of the lower portal gear.

FIG. 12 is a perspective view of one embodiment of a portal hub adapter according to one embodiment of the present invention. FIG. 13 shows this adapter in a cross-sectional view. And, FIG. 14, shows a side view of the hub adaptor.

FIG. 15 presents another embodiment of the present invention. A three dimensional exploded view of a portal axle is shown. A portal gear box housing 21 is shown. Exploded from within the portal gear box housing 21 is the input yoke 28, upper gear 5, lower portal gear 23, lower inner bearing 2, lower outer bearing 1, and the output shaft 25. The lower portal gear 23 is located between the lower inner and outer bearings 1,2. The spindle/mounting plate 29 is mounted with the portal gear box 21. The output shaft 25 of the portal axle is coupled with a drive plate 27 that drives the hub assembly 9 and the rotor 7. The drive plate 27 may also include a drive plate cap 20. A brake caliper 8 is shown mounted to the spindle mounting plate 29 via the caliper mounting boss 26 and placed over the rotor 7. A variety of seals 14, 18, 19 and bearings 4, 10, 16, are also shown. The input yolk 28 as shown is coupled to the upper gear 5. The upper gear 5 is in contact with the lower portal gear 23. In this specific embodiment the upper gear comprises 16 teeth and the lower portal gear 23 comprises 33 teeth. These gears may comprise a variety of other number of teeth. Depending on the specific application the gears may have the same number of teeth; the upper may have more teeth, etc.

The lower portal gear 23 is coupled with the output shaft 25 between the lower inner and outer bearings 1, 2. These bearings transfer any load from the output shaft to the portal gear box rather than onto the upper and lower portal gears 5, 23. The upper gear 5 as shown in FIG. 15 is coupled to the input yoke between two bearings 4, 16. Both the upper and lower portal gears 5, 23, for example, may be loaded into a one piece portal gear box without disassembling the one piece gear box.

In embodiments of this invention the upper and lower gears are free floating within the gear box. Other embodiments of the present invention allow for more than one lower inner bearing 2 and/or more than one lower outer bearing 1.

In another embodiment of the present invention, an indexed and mate-fitted steering arm 24 is coupled to the top of the portal gear box as shown in FIG. 15. An exemplary steering arm alone is shown in FIG. 16. An indexed and mate-fitted steering arm 24 may, for example, allow for multiple steering geometries by changing only the steering arm and re-utilizing the gear box with a new steering arm. The portal gear box, in this embodiment, includes indexes or mated portions that allow for quick removal and replacement of steering arms.

The portal axel may also be attached, for example, to the center axle of a vehicle by a tapered bearing in place of a traditional ball joint. Such a configuration may, for example, lessen the negative load characteristics that may plague a ball joint in high stress conditions.

The present invention may be embodied in other specific forms without departing from its spirit or essential characteristics. The described embodiments are to be considered in all respects only as illustrative, and not restrictive. All changes which come within the meaning and range of equivalency of this disclosure are to be embraced within its scope.

What is claimed is:

1. A portal gear box housing comprising:
an upper gear housed within said portal gear box;
a lower portal gear housed within said portal gear box and in contact with said upper gear;
at least one lower inner bearing mount and at least one lower outer bearing mount;
a lower inner bearing mounted at said lower inner bearing mount; and
a lower outer bearing mounted at said lower outer bearing mount,
wherein said output shaft is rotatably coupled within said lower inner bearing and within said lower outer bearing and coupled to said lower portal gear thus fully suspending the output shaft within the portal gear box, and wherein the lower inner bearing and the lower outer bearing alleviate the load on the torque bearing surfaces of the lower portal gear.

2. The portal gear box housing of claim 1 wherein said upper and lower portal gears are capable of being loaded within said portal gear box without disassembly.

3. The portal gear box housing of claim 1 further comprising a spindle mounting plate.

4. The portal gear box housing of claim 1 further comprising an indexed steering arm.

5. The portal axle of claim 1 wherein said upper gear comprises fewer teeth than said lower portal gear.

6. The portal axle of claim 1 wherein said portal gear box housing is a single unit.

7. The portal axle of claim 1 further comprising an input yolk coupled with said upper gear.

8. The portal axle of claim 1 further comprising:
at least one upper inner bearing mount and at least one upper outer bearing mount;
a upper inner bearing mounted at said upper inner bearing mount; and
a upper outer bearing mounted at said upper outer bearing mount,
wherein said input yoke is rotatably coupled within said upper inner bearing and within said upper outer bearing and coupled to said upper gear thus fully suspending the input yoke within the portal gear box, and wherein the upper inner bearing and the upper outer bearing alleviate the load on the torque bearing surfaces of the upper gear.

9. A portal axle comprising:
a portal gear box housing with a lower inner bearing mount and a lower outer bearing mount;
an output shaft;
an input yolk;
an upper gear coupled with said input yolk;
a lower portal gear coupled with said output shaft and in contact with said upper gear;
a lower inner bearing mounted within said portal gear box at said lower inner bearing mount; and
a lower outer bearing mounted within said portal gear box at said lower outer bearing mount,
wherein said output shaft is rotatably coupled with said lower inner bearing and said lower outer bearing.

10. The portal axle of claim 9 further comprising
a spindle mounting plate encasing said output shaft;
a rotor coupled with said spindle mounting plate; and
a hub assembly coupled with said rotor,
wherein said spindle mounting plate is within the hub assembly.

11. A vehicle comprising:
an engine, a drive train and wheels;
a portal gear box housing coupled with each wheel of said vehicle, wherein the portal gear boxes in combination support the weight of the vehicle, the portal gearbox comprising:
a lower inner bearing mount and a lower outer bearing mount, wherein said portal gear box;
an output shaft;
an input yolk coupled with the drive train of said vehicle;
an upper gear coupled with said input yolk;
a lower portal gear coupled with said output shaft and in contact with said upper gear;
a lower inner bearing mounted within said portal gear box at said lower inner bearing mount; and
a lower outer bearing mounted within said portal gear box at said lower outer bearing mount,
wherein said output shaft is rotatably coupled with said lower inner bearing and said lower outer bearing.

12. The vehicle of claim 11 further comprising
a spindle mounting plate encasing said output shaft;
a rotor coupled with said spindle mounting plate; and
a hub assembly coupled with said rotor,
wherein said spindle mounting plate is within the hub assembly.
